(19) United States
(12) Patent Application Publication
(10) Pub. No.: US 2010/0149049 A1
(43) Pub. Date: Jun. 17, 2010

(54) BROADBAND ANTENNA OF DUAL RESONANCE

(76) Inventors: Byung Hoon Ryou, Seoul (KR); Won Mo Sung, Gyeonggi-do (KR); Jae Hoon Choi, Seoul (KR); Seong Gil Jeon, Seoul (KR); Kwang Woo Ryu, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/593,275

(22) PCT Filed: Apr. 3, 2008
(86) PCT No.: PCT/KR2008/001876

§ 371 Date: Dec. 10, 2009

(30) Foreign Application Priority Data
Apr. 4, 2007 (KR) 10-2007-0033058

(51) Int. Cl. H01Q 5/00; H01Q 1/24; H01Q 9/04; H01Q 1/50

(52) U.S. Cl. 343/702; 343/700 MS; 343/859

(57) ABSTRACT

Disclosed herein is a dual-resonance broadband antenna, and more particularly, to such a dual-resonance broadband antenna in which dual resonance is caused to occur using an antenna consisting of a strip line, a microstrip line or the like having a meander pattern so as to receive a signal for a wireless communication service at a relatively low frequency band, particularly, a signal with a terrestrial digital multimedia broadcasting (T-DMB) service frequency band of 174-216 MHz among a very high frequency (VHF) band. Particularly, the dual-resonance broadband antenna of the present invention is remarkably red used in its size (length) as compared to a general helical antenna, a monopole antenna, a dipole antenna or the like while using a wireless communication service at a relatively low frequency band, thereby achieving miniaturization thereof. Further, it is possible to improve quality and reliability of the small-sized dual-resonance broadband antenna according to the present invention as well as enhance the qualities of a portable terminal and a transmission and reception device for wireless communication employing the antenna according to the present invention.

### TECHNICAL FIELD

The present invention relates to a dual-resonance broadband antenna, and more particularly, to such a dual-resonance broadband antenna in which dual resonance is caused to occur using an antenna consisting of a strip line, a microstrip line or the like having a meander pattern so as to receive a signal for a wireless communication service at a relatively low frequency band, particularly, a signal with a terrestrial digital multimedia broadcasting (T-DMB) service frequency band of 174-216 MHz among a very high frequency (VHF) band of 30-300 MHz.

Particularly, the present invention relates to a dual-resonance broadband antenna which is remarkably reduced in its size as compared to a general helical antenna, a monopole antenna, a dipole antenna or the like and enables miniaturization while using a wireless communication service at a relatively low frequency band, thereby improving quality and reliability thereof as well as enhancing the qualities of a portable terminal and a transmission and reception device for wireless communication employing the antennal according to the present invention.

### BACKGROUND ART

Along with the advancement of electronic industries, and the development of communication technologies, particularly, wireless communication technologies, various portable terminals have been developed and generalized which can perform voice and data communication with anyone, anytime and anywhere. Also, a variety of techniques for implementing miniaturization of the portable terminals, for example, the development of high-density integrated circuit device, a miniaturizing method of an electronic circuit board and the like are developed to improve portability of the portable terminals. Since the purpose of using the portable terminals is also diversified, terminals are developed which are capable of performing various functions such as a navigation terminal, an Internet terminal or the like.

Currently, since a terrestrial broadcasting service using the VHF band of 30-300 MHz is provided to users, portable terminals and antennas capable of receiving such a terrestrial broadcasting are developed.

In general, an antenna of a portable terminal capable of receiving such a terrestrial broadcasting has been mainly implemented in the form of a helical antenna, a monopole antenna, a dipole antenna or the like.

However, in consideration of the characteristics of the terrestrial broadcasting using a relatively low frequency band, the above-mentioned antennas have lots of limitations in their sizes to receive the terrestrial broadcasting service, and thus cause many limitations in sizes of the portable terminals.

Particularly, in order to achieve the broadband radiation characteristics, the size of an antenna must be increased. Accordingly, this problematically serves as a stumbling block to miniaturization of an antenna and the portable terminal mounted with the antenna.

Therefore, there is a need for the development of an antenna which enables a wireless communication service at a relatively low frequency band and also enables its miniaturization while having broadband characteristics.

### DISCLOSURE OF INVENTION

### Technical Problem

Accordingly, an object of the present invention has been made in an effort to solve the above-mentioned problems occurring in the prior art, and it is an object of the present invention to provide a dual-resonance broadband antenna in which dual resonance is caused to occur using an antenna consisting of a strip line, a microstrip line or the like having a meander pattern so as to receive a signal for a wireless communication service at a relatively low frequency band, particularly, a signal with a terrestrial digital multimedia broadcasting (T-DMB) service frequency band of 174-216 MHz among a very high frequency (VHF) band of 30-300 MHz.

Another object of the present invention is to provide a dual-resonance broadband antenna which is remarkably reduced in its size as compared to a general helical antenna, a monopole antenna, a dipole antenna or the like while using a wireless communication service at a relatively low frequency band, thereby achieving miniaturization thereof.

Yet another object of the present invention is to provide a dual-resonance broadband antenna which improves quality and reliability thereof as well as enhancing the qualities of a portable terminal and a transmission and reception device for wireless communication employing the antenna according to the present invention.

### Technical Solution

To accomplish the above object, according to one aspect of the present invention, there is provided a dual-resonance broadband antenna comprising: a first radiator having a first resonance length formed on one surface of a dielectric in a meander pattern for generating resonance at a first resonant frequency; a second radiator having a second resonance length formed on the other surface of the dielectric in a meander pattern for generating resonance at a second resonant frequency; a ground section formed on the one surface of the dielectric; a connecting section formed on the one surface of the dielectric so as to be electrically connected with the second radiator; a first inductor adapted to be connected with the connecting section and the ground section; and a feed element formed on the one surface of the dielectric so as to be electrically connected with the first radiator.

Accordingly, it is possible to provide a miniaturized antenna having broadband characteristics by using a single antenna, preferably, an antenna of a meander pattern.

### ADVANTAGEOUS EFFECTS

As described above, according to a dual-resonance broadband antenna of the present invention, dual resonance is caused to occur using an antenna consisting of a strip line, a microstrip line or the like having a meander pattern, such that it is possible receive a signal for a wireless communication service at a relatively low frequency band, particularly, a signal with a terrestrial digital multimedia broadcasting (T-DMB) service frequency band using a very high frequency (VHF) band.

In addition, the dual-resonance broadband antenna of the present invention is remarkably reduced in its size as compared to a general helical antenna, a monopole antenna, a dipole antenna or the like while using a wireless communication service at a relatively low frequency band, thereby achieving miniaturization thereof.

Particularly, a plurality of tuning sections is provided in a single antenna so that a corresponding antenna can be more easily applied to different portable terminals.

Further, it is possible to improve quality and reliability of the small-sized dual-resonance broadband antenna according to the present invention as well as enhance the qualities of a portable terminal and a transmission and reception device for wireless communication employing the antenna according to the present invention.

### BRIEF DESCRIPTION OF THE DRAWINGS

FIG. 1 is an exploded perspective view showing an example of a dual-resonance broadband antenna according to the present invention;

FIG. 2 is an exploded perspective view showing another example of a dual-resonance broadband antenna according to the present invention;

FIG. 3 is an enlarged view showing a main portion of FIG. 2;

FIG. 4 is a graph showing a voltage standing wave ratio (VSWR) of the dual-resonance broadband antenna shown in FIG. 2; and

FIG. 5 is a diagrammatic view showing radiation patterns at resonant frequencies of the dual-resonance broadband antenna shown in FIG. 2.

### BEST MODE FOR CARRYING OUT THE INVENTION

The preferred embodiment of dual-resonance broadband antenna according to the present invention will be described hereinafter with reference to the accompanying drawings.

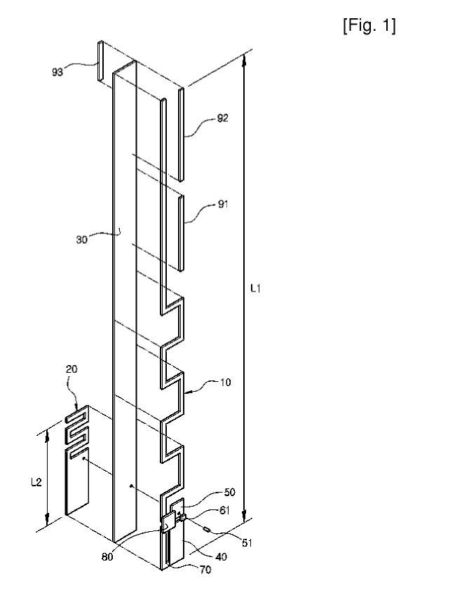

FIG. 1 is an exploded perspective view showing an example of a dual-resonance broadband antenna according to the present invention.

The dual-resonance broadband antenna of the present invention includes a first radiator 10, a second radiator 20, a dielectric 30, a ground section 40, a connecting section 50, a first inductor 61 and a feed element 70. The first radiator 10 and the second radiator 2 is formed in a meander pattern in which a “□”-shape pattern is repeatedly connected to each other.

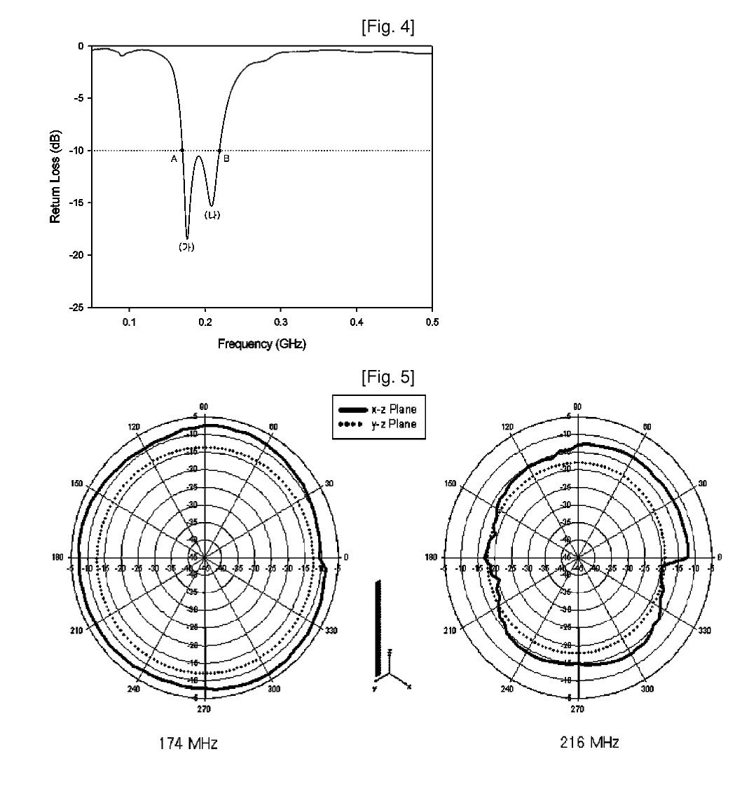

The first radiator 10 serves to generate resonance at a first resonant frequency corresponding to (□) indicated in the graph of FIG. 4, for example, at 174 MHz included in a VHF frequency band. The first radiator 10 generates the first resonant frequency through an interaction with the first inductor 61. The term “interaction” as used herein refers to at least one of all the phenomena where two elements have electrical and magnetic influences on each other.

In the meantime, typically in order to generate resonance at 174 MHz, a dipole antenna has a length of about 76 cm corresponding to λ/2, a monopole antenna has a length of about 38 cm corresponding to λ/4. However, in the present invention, the first radiator 10 is formed in a “□”-shaped meander pattern so that its electric pattern length is identical to that of the monopole antenna but the size of the entire antenna may be implemented with a first resonance length of 13 cm.

In addition, the resonant frequency and the broadband characteristics can be controlled depending to the number of meanderings constituting the “□”-shaped meander pattern.

The second radiator 20 serves to generate resonance at a second resonant frequency corresponding to (□) indicated in the graph of FIG. 4, for example, at 216 MHz included in the VHF frequency band. The second radiator 20 generates the first resonant frequency through an interaction with the first radiator 10. In this case, the first radiator 10 and the second radiator 20 act as a single dipole antenna.

Thus, the antenna according to the present invention has the broadband characteristics in which it is possible to utilize an interval of less than −10 dB, i.e., a frequency band between a frequency of a point “A” and a frequency of a point “B” as shown in FIG. 4 using the dual resonance generated from the first radiator 10 and the second radiator 20.

The dielectric 30 is disposed between the first radiator 10 and the second radiator 20, and the kind of the dielectric 30 can be applied variously depending on the demand of a person skilled in the art. Also, it is natural that it is possible to obtain an effect of reducing an electrical length through the interaction between the dielectric 30 and the first and second radiators 10 and 20

The ground section 40 and the connecting section 50 are formed on one surface of the dielectric 30, preferably, on a surface flush with a top surface of the first radiator 10. The ground section 40 is electrically connected with the connecting section 50, and the connecting section 50 is electrically connected with the second radiator 20. In this case, the connecting section 50 and the second radiator 20 are electrically connected with each other by means of a connecting member 51 made of a metal material.

Further, the ground section 40 and the connecting section 50 are electrically connected with each other by means of the first inductor 61, and the feed element 70 is connected with feed means (not shown) such as a coaxial cable, etc., so as to form a transmission line for transmission and reception of a signal.

In the meantime, the ground section 40 is designed to have an infinite size during the design of the antenna. But, the ground section 40 is actually connected to a portable terminal, it has a limitation in its size. In this case, the first radiator 10 and the second radiator 20 can be influenced by the ground section 40.

In order to prevent this, the broadband antenna of the present invention includes a balun chip 80 for allowing the first radiator 10 and the connecting section 50 to be electrically connected with each other by means of an inductance component, and allowing the ground section 40 and the feed element 70 to be electrically connected with each other by means of an inductance component so as to convert an non-parallel line into a parallel line.

In this case, the balun chip 80 was originally used to interconnect the coaxial cable and the parallel line, but is currently used to convert the non-parallel line into a parallel line, and vice-versa. In the present invention, the balun chip 80 is used to remove the influence of the ground section 40 on the first and second radiators 10 and 20.

In other words, the first radiator 10 is electrically connected with the ground section 40 by means of the balun chip 80, the connecting section 50 and the first inductor 61. The second radiator 10 is electrically connected with the ground section 40 by means of the connecting member 51, the connecting section 50 and the first inductor 61.

Thus, a resonance is generated at a first resonant frequency by the first radiator 10 having a first resonance length L1 of FIG. 1, and the first inductor 61, and a resonance is generated at a second frequency by the first radiator 10 and the second radiator 20 having a second resonance length L2 of FIG. 1.

In the meantime, in case where an antenna including the first radiator 10 and the second radiator 20 is configured to be connected to a portable terminal, there may occur a phenomenon where the resonant frequency is changed due to the impedance matching with the portable terminal or several factors upon the connection between the antenna and the portable terminal, and hence the antenna is subjected to a tuning process in which the change of the resonant frequency is tuned, a reflection loss is reduced, etc.

In order to perform the tuning process, as shown in FIG. 1, a first tuning section 91 and a second tuning section 92 are formed on one surface of the dielectric 30, and a third tuning section 93 is formed on the other surface of the dielectric 30.

Accordingly, the tuning process is performed by controlling the lengths, etc., of the first tuning section 91, the second tuning section 92 and the third tuning section 93 depending on the demand of a person skilled in the art.

The aim at forming the plurality of tuning sections is impart flexibility to the tuning works to so as to perform a more effective tuning process depending on the demand of a person skilled in the art in applying the antenna to different various portable terminals.

Thus, in case of applying the antenna according to the present invention to a specific portable terminal, the tuning process can be carried out more effectively by a plurality of tuning sections configured in a single antenna so that the inventive antenna can be more easily applied to different portable terminals.

Meanwhile, it is possible to transmit and receive a signal by using various bandwidths through the dual resonance of the antenna according to the present invention depending on the demand of a person skilled in the art.

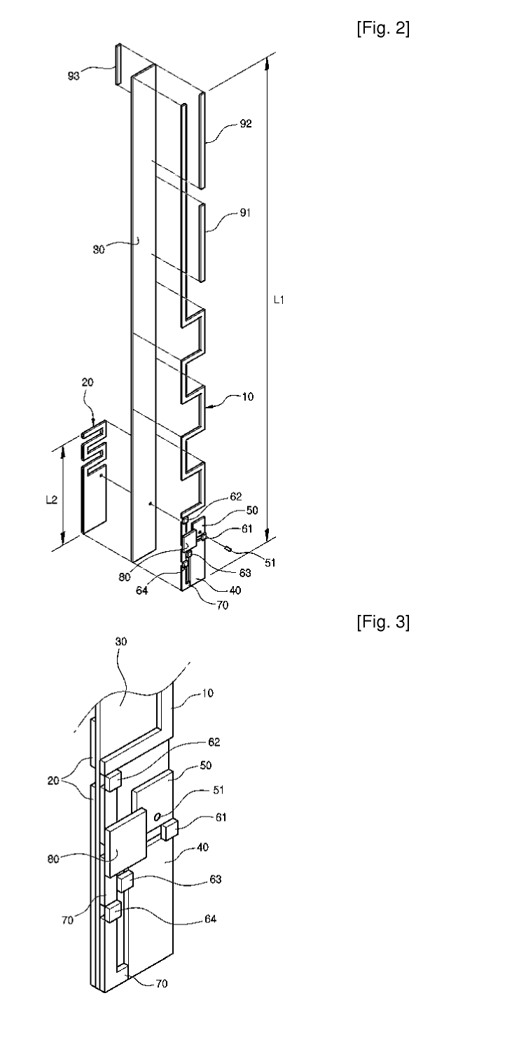

In other words, as shown in FIGS. 2 and 3, a second inductor 62 is formed at one side of the first radiator 10, and the band of the first resonant frequency and the second resonant frequency is adjusted depending on the size of the second inductor 62 so that the inventive antenna can be applied to portable terminals having different service frequency band.

Furthermore, for the sake of the impedance matching (typically, 50Ω) of the antenna according to the present invention, as shown in FIGS. 2 and 3, a third inductor 63 is disposed between the ground section 40 and the feed element 70 so as to be connected with the ground section 40 and the feed element 70, and a capacitor 64 is mounted at one side of the feed element 70.

Simulation and measurement data for the voltage standing wave ratio (VSWR) of the broadband antenna according to the present invention as constructed above are shown in the graph of FIG. 4. It can be seen from FIG. 5 that the radiation pattern of the broadband antenna according to the present invention can be realized in all directions.

FIG. 5 is a diagrammatic view showing radiation patterns of the dual-resonance broadband antenna at a first resonant frequency (174 MHz) corresponding to (□) indicated in the graph of FIG. 4 and a second resonant frequency (216 MHz) corresponding to (□) indicated in the graph of FIG. 4.

The dual-resonance broadband antenna according to the present invention has been described above. A person skilled in the art will appreciate that the present invention can be implemented in other concrete forms without any modification of the technical construction or the essential features of the present invention.

Moreover, it is natural that various portable terminals, transmission/reception devices for wireless communication and the like using the dual-resonance broadband antenna according to the present invention can fall within the scope of the present invention.

Therefore, the embodiments set forth above are merely illustrative and not meant to be limitations, and the scope of the present invention is defined by the claims which will be described later, but not the aforementioned description. All the modifications derived from meanings and scope of the claims as well as equivalents thereof or modified forms should be construed as falling within the scope of the present invention.

1. A dual-resonance broadband antenna, comprising:
a first radiator having a first resonance length formed on one surface of a dielectric in a meander pattern for generating resonance at a first resonant frequency;
a second radiator having a second resonance length formed on the other surface of the dielectric in a meander pattern for generating resonance at a second resonant frequency:
a ground section formed on the one surface of the dielectric;
a connecting section formed on the one surface of the dielectric so as to be electrically connected with the second radiator;
a first inductor adapted to be connected with the connecting section and the ground section; and
a feed element formed on the one surface of the dielectric so as to be electrically connected with the first radiator.

2. The broadband antenna according to claim 1, wherein a second inductor is formed at one side of the first radiator so as to allow a frequency tuning process to be performed at the first resonant frequency through the interaction with the first radiator and the first inductor.

3. The broadband antenna according to claim 1, wherein a second inductor is formed at one side of the first radiator so as to allow a frequency tuning process to be performed at the second resonant frequency through the interaction with the first radiator and the second radiator.

4. The broadband antenna according to claim 1, wherein a third inductor is disposed between the ground section and the feed element so as to be connected with the ground section and the feed element, and a capacitor is mounted at one side of the feed element, such that by the third inductor and the capacitor.

5. The broadband antenna according to claim 1, wherein the first radiator and the connecting section as well as the feed element and the ground section are connected with each other by means of a balun chip for converting an non-parallel line into a parallel line.

6. The broadband antenna according to claim 5, wherein at least one of first to third tuning sections is provided in such a fashion that the first tuning section or the second tuning section is formed on one surface of the dielectric, and the third tuning section is formed on the other surface of the dielectric so as to tune with the first resonant frequency and the second resonant frequency.

7. A wireless communication device configured with a dual-resonance broadband antenna comprising:
a first radiator having a first resonance length formed on one surface of a dielectric in a meander pattern for generating resonance at a first resonant frequency;
a second radiator having a second resonance length formed on the other surface of the dielectric in a meander pattern for generating resonance at a second resonant frequency:
a ground section formed on the one surface of the dielectric;
a connecting section formed on the one surface of the dielectric so as to be electrically connected with the second radiator;
a first inductor adapted to be connected with the connecting section and the ground section; and
a feed element formed on the one surface of the dielectric so as to be electrically connected with the first radiator.
